(19) United States
(12) Patent Application Publication
(10) Pub. No.: US 2026/0258258 A1
(43) Pub. Date: Sep. 3, 2026

(54) ZIF-8-BASED PHOTOTHERMAL SUPERHYDROPHOBIC ANTI-CORROSION AND ANTI-ICING COATING AND PREPARATION METHOD THEREOF

(71) Applicant: Institute of Oceanology, Chinese Academy of Sciences, Qingdao City, Shandong Province (CN)

(72) Inventors: Binbin ZHANG, Qingdao City (CN); Xiaozhuo LIU, Qingdao City (CN)

(21) Appl. No.: 19/428,090

(22) Filed: Dec. 19, 2025

(30) Foreign Application Priority Data
Feb. 28, 2025 (CN) 2025102281972

(51) Int. Cl. C09D 5/08; C09D 5/16; C09D 7/61; C09D 7/80

(52) U.S. Cl. CPC C09D 5/086; C09D 5/1681; C09D 7/61; C09D 7/80

(57) ABSTRACT

The present disclosure discloses a method for preparing a ZIF-8-based photothermal superhydrophobic anti-corrosion and anti-icing coating, including the following steps: S1: preparation of ZIF-8@PDA particles: synthesizing polydopamine modified ZIF-8@PDA particles in water in one step; and S2: preparation of ZIF-8-based photothermal superhydrophobic anti-corrosion and anti-icing coating: compounding the ZIF-8@PDA with a carbon material in a certain ratio for performing superhydrophobic modification, adding an adhesive, performing spraying on a surface of a substrate, and performing curing to obtain the ZIF-8-based photothermal superhydrophobic anti-corrosion and anti-icing coating. The ZIF-8-based photothermal superhydrophobic anti-corrosion and anti-icing coating material prepared in the present disclosure exhibits excellent superhydrophobicity, mechanical stability, and corrosion resistance. Also, the ZIF-8-based photothermal superhydrophobic anti-corrosion coating exhibits excellent passive delayed icing and active photothermal deicing capabilities on a surface of an aluminum alloy, and provides a novel strategy for deicing of industrial facilities and equipment in winter.

### CROSS-REFERENCE TO RELATED APPLICATIONS

This application claims priority to Chinese Patent Application No. 202510228197.2, filed on Feb. 28, 2025, which is incorporated herein by reference in its entirety.

### TECHNICAL FIELD

The present disclosure belongs to the technical field of superhydrophobic coatings, and specifically relates to a ZIF-8-based photothermal superhydrophobic anti-corrosion and anti-icing coating and a preparation method thereof.

### BACKGROUND

Marine engineering facilities and equipment not only face corrosion problems caused by harsh marine environments, but also face ice covering problems in winter. A synergistic effect of corrosion and ice covering is particularly evident in damage to marine engineering facilities and equipment. Water generated after melting of ice may accelerate corrosion, and a rough-surfaced corrosion product produced by corrosion provides more attachment points for formation of ice crystals, further accelerating an icing process. Such a vicious cycle may significantly shorten the service life of facilities and equipment and increase maintenance costs and safety hazards.

In recent years, superhydrophobic coatings (having a contact angle with water greater than 150° and a rolling angle less than 10°) with a special solid-liquid contact state have attracted much attention in the scientific and industrial communities. A surface non-wettability and liquid repellency of the superhydrophobic coatings have demonstrated significant advantages in the fields such as self-cleaning, anti-corrosion, anti-fouling, and anti-icing.

Although the superhydrophobic coatings have significant advantages in the fields of anti-corrosion and anti-icing on metal surfaces, they can only delay icing and cannot actively remove ice. As an ice layer accumulates, once a superhydrophobic coating is completely covered by the ice layer, the superhydrophobic coating fails to achieve an anti-icing effect. This greatly hinders further development of the superhydrophobic coatings in the field of anti-icing. Deicing technologies in the prior art such as electro-thermal deicing, mechanical deicing, and chemical deicing not only have low efficiency but also have corrosive effects on metals. Therefore, developing a superhydrophobic anti-corrosion and anti-icing coating with an active deicing function is of great significance.

### SUMMARY

Based on the above, the present disclosure provides a photothermal superhydrophobic anti-corrosion and anti-icing coating and a preparation method thereof, with a main objective of providing a ZIF-8-based photothermal superhydrophobic anti-corrosion and anti-icing coating with passive delayed anti-icing and active photothermal deicing functions.

The present disclosure provides a method for preparing a ZIF-8-based photothermal superhydrophobic anti-corrosion and anti-icing coating, including the following steps:
S1: preparation of ZIF-8@PDA particles: dissolving a zinc salt and dopamine hydrochloride in deionized water to form a solution A, dissolving 2-methylimidazole in deionized water to form a solution B, mixing and stirring the solution A with the solution B at room temperature for a period of time to obtain a black turbid solution, and performing centrifugal washing and freeze drying to obtain the polydopamine modified ZIF-8 particles ZIF-8@PDA; and
S2: preparation of a ZIF-8-based photothermal superhydrophobic anti-corrosion and anti-icing coating: dispersing the ZIF-8@PDA and a carbon material in a certain ratio in ethanol by stirring, allowing the mixture to react with modifiers in an alkaline environment for a period of time, performing centrifugation, adding an organic solvent and an adhesive, performing stirring evenly to obtain a ZIF-8-based photothermal superhydrophobic anti-corrosion and anti-icing coating material, spraying the coating material onto a surface of a substrate, and curing the coating material to obtain the ZIF-8-based photothermal superhydrophobic anti-corrosion and anti-icing coating.

An air layer captured by the superhydrophobic coating can effectively reduce a solid-liquid contact area, which can not only block direct contact between a corrosive medium and a material surface, but also delay formation and adhesion of ice crystals.

Further, the zinc salt is one of zinc nitrate, zinc acetate, and zinc gluconate in S1.

Further, in S1, the mass concentration of the dopamine hydrochloride in the solution A is 0.1 g/mL, and the mass concentration of the zinc salt in the solution A is 0.02 g/mL.

Further, the mass ratio of the zinc salt to the 2-methylimidazole is 1:(5-10) in S1.

Further, the stirring time at room temperature is 12-48 h, preferably 24 h in S1.

Further, the mass ratio of the ZIF-8@PDA to the carbon material is 1:(0.25-1) in S2.

Further, the carbon material is one or more of carbon black, carbon nanotubes, and graphene.

Further, 6 g of a mixture of the ZIF-8@PDA with the carbon material is dispersed per 250-350 mL of ethanol.

Further, the alkaline environment is formed by adding an ammonia solution to ethanol in S2.

Further, the modifiers are tetraethyl silicate and hexadecyltrimethoxysilane in S2.

Further, the volume ratio of the ethanol to the ammonia solution to the tetraethyl silicate to the hexadecyltrimethoxysilane is 50:0.6:0.6:0.6 in S2.

Further, the organic solvent is one of butyl acetate, ethanol, and ethyl acetate in S2.

Further, the adhesive is one or more of isopropyl phenyl diphenyl phosphate, polysilazane, epoxy resin, polydimethylsiloxane, and thermoplastic polyurethane in S2.

Further, in S1, the carbon material is preferably carbon black, and in S2, the organic solvent is preferably butyl acetate, and the adhesive is preferably polysilazane and isopropyl phenyl diphenyl phosphate. Carbon black is cheaper and has a wider range of sources compared to other carbon materials. As an emerging adhesive, polysilazane can self-cure without the need for a curing agent or harsh curing condition compared to traditional adhesives such as epoxy resin and polydimethylsiloxane. A synergistic effect of the isopropyl phenyl diphenyl phosphate and the polysilazane prolongs the dispersion time of a corrosive medium, significantly improves the oxidation resistance of the carbon material, and enhances the anti-corrosion performance of a coating.

In the present disclosure, the ZIF-8-based photothermal superhydrophobic anti-corrosion and anti-icing coating is prepared from the micrometer sized ZIF-8@PDA and the nanometer sized carbon material as photothermal superhydrophobic particles, and the adhesive. Firstly, a substance having a low surface energy and an air layer captured by a surface micro-nano structure, of the coating, can achieve physical barrier against a corrosive medium, thereby endowing the coating with certain anti-corrosion performance and also serving the purpose of delaying icing. Also, the micro-nano structure on the surface of the coating allows sunlight to be reflected and absorbed multiple times on the surface of the coating, similar to a “trap” that captures the sunlight, thereby improving the absorption rate of the coating to sunlight, endowing the coating with certain photothermal performance, and serving the purpose of active photothermal deicing. The ZIF-8-based photothermal superhydrophobic anti-corrosion and anti-icing coating can meet the needs of the fields of metal anti-corrosion and anti-icing, such as marine ships, coastal infrastructure, petroleum, chemistry, power, and automobiles.

### BRIEF DESCRIPTION OF THE DRAWINGS

FIG. 1 shows the effects of droplets having different properties on a surface of Example 1.

FIG. 2 shows infrared thermal images of an aluminum alloy, Comparative Example 1, and Example 1 heated up in 10 min under one solar intensity.

FIG. 3 shows delayed icing processes of an aluminum alloy, Comparative Example 1, and Example 1 at −15° C.

FIG. 4 shows photothermal ice melting processes of an aluminum alloy, Comparative Example 1, and Example 1 under one solar intensity.

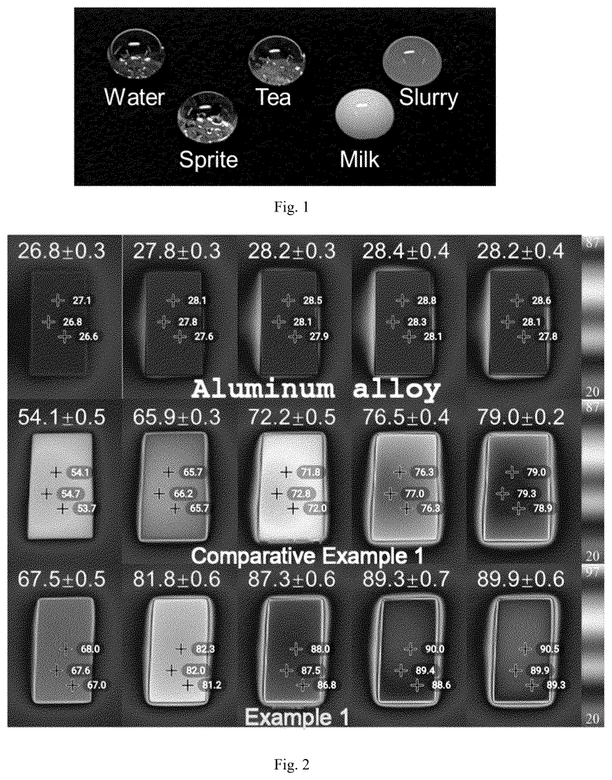

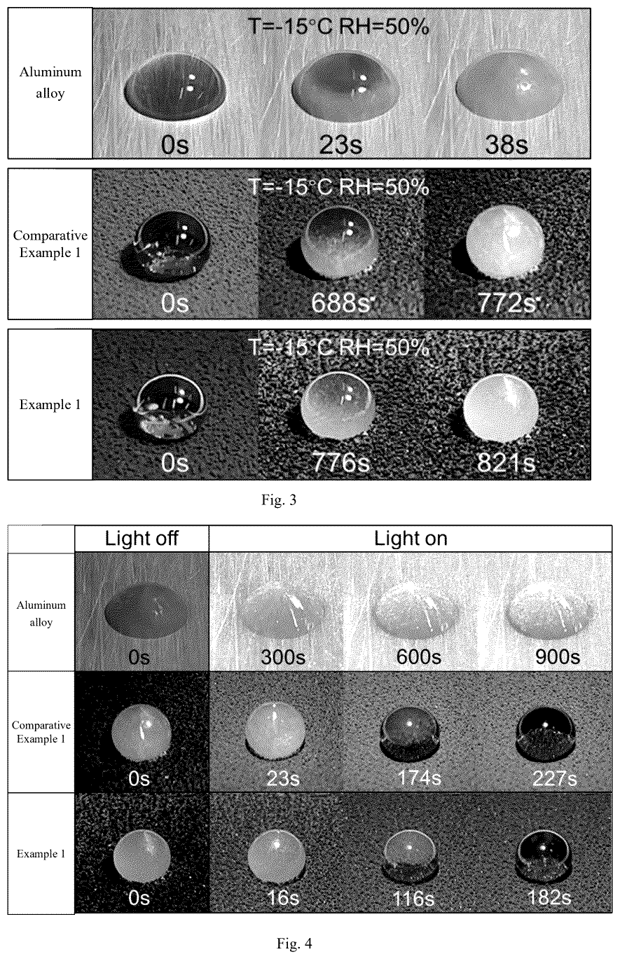

### DETAILED DESCRIPTION OF THE EMBODIMENTS

The preparation and performance of the ZIF-8-based photothermal superhydrophobic anti-corrosion coating of the present disclosure are further explained through specific examples.

### Example 1

S1: Preparation of ZIF-8@PDA particles: 12.25 g of zinc gluconate and 0.10 g of dopamine hydrochloride were dissolved in 300 mL of deionized water to form a solution A. 16.00 g of 2-methylimidazole was dissolved in 200 mL of deionized water to form a solution B. The solution A was mixed with the solution B and stirred at room temperature for 24 h to obtain a black turbid solution, and the black turbid solution was centrifugally washed and freeze-dried to obtain the ZIF-8@PDA particles.

S2: Preparation of a ZIF-8-based photothermal superhydrophobic anti-corrosion coating: 0.30 g of the ZIF-8@PDA and 0.30 g of carbon black were dispersed in 25 mL of ethanol. 0.3 mL of aqueous ammonia, 0.3 mL of tetraethyl silicate, and 0.3 mL of hexadecyltrimethoxysilane were added sequentially for reaction for 4 h, and then centrifugation was performed. 10 mL of butyl acetate, 1.20 g of polysilazane, and 0.1 g of isopropyl phenyl diphenyl phosphate were added and stirred evenly to obtain a ZIF-8-based photothermal superhydrophobic anti-corrosion coating material. The coating material was sprayed onto a surface of an aluminum alloy and cured to obtain the ZIF-8-based photothermal superhydrophobic anti-corrosion coating.

### Example 2

S1: Preparation of ZIF-8@PDA particles: 12.25 g of zinc gluconate and 0.10 g of dopamine hydrochloride were dissolved in 300 mL of deionized water to form a solution A. 8.00 g of 2-methylimidazole was dissolved in 200 mL of deionized water to form a solution B. The solution A was mixed with the solution B and stirred at room temperature for 36 h to obtain a black turbid solution, and the black turbid solution was centrifugally washed and freeze-dried to obtain the ZIF-8@PDA particles.

S2: Preparation of a ZIF-8-based photothermal superhydrophobic anti-corrosion coating: 0.48 g of the ZIF-8@PDA and 0.12 g of carbon nanotubes were dispersed in 25 mL of ethanol. 0.3 mL of aqueous ammonia, 0.3 mL of tetraethyl silicate, and 0.3 mL of hexadecyltrimethoxysilane were added sequentially for reaction for 6 h, and then centrifugation was performed. 10 mL of ethanol and 0.60 g of epoxy resin (E-44 epoxy resin and a polyamide 650 curing agent in a mass ratio of 1:1) were added and stirred evenly to obtain a ZIF-8-based photothermal superhydrophobic anti-corrosion coating material. The coating material was sprayed onto a surface of glass and cured to obtain the ZIF-8-based photothermal superhydrophobic anti-corrosion coating.

### Example 3

S1: Preparation of ZIF-8@PDA particles: 7.80 g of zinc nitrate and 0.10 g of dopamine hydrochloride were dissolved in 300 mL of deionized water to form a solution A. 16.00 g of 2-methylimidazole was dissolved in 200 mL of deionized water to form a solution B. The solution A was mixed with the solution B and stirred at room temperature for 48 h to obtain a black turbid solution, and the black turbid solution was centrifugally washed and freeze-dried to obtain the ZIF-8@PDA particles.

S2: Preparation of a ZIF-8-based photothermal superhydrophobic anti-corrosion coating: 0.40 g of the ZIF-8@PDA and 0.20 g of graphene were dispersed in 25 mL of ethanol. 0.3 mL of aqueous ammonia, 0.3 mL of tetraethyl silicate, and 0.3 mL of hexadecyltrimethoxysilane were added sequentially for reaction for 2 h, and then centrifugation was performed. 15 mL of ethyl acetate and 1.10 g of polydimethylsiloxane (Sylgard 184 type A polydimethylsiloxane and Sylgard 184 type B curing agent in a mass ratio of 10:1) were added and stirred evenly to obtain a ZIF-8-based photothermal superhydrophobic anti-corrosion coating material. The coating material was sprayed onto a surface of a wood board and cured to obtain the ZIF-8-based photothermal superhydrophobic anti-corrosion coating.

### Example 4

S1: Preparation of ZIF-8@PDA particles: 5.91 g of zinc acetate and 0.10 g of dopamine hydrochloride were dissolved in 300 mL of deionized water to form a solution A. 16.00 g of 2-methylimidazole was dissolved in 200 mL of deionized water to form a solution B. The solution A was mixed with the solution B and stirred at room temperature for 12 h to obtain a black turbid solution, and the black turbid solution was centrifugally washed and freeze-dried to obtain the ZIF-8@PDA particles.

S2: Preparation of a ZIF-8-based photothermal superhydrophobic anti-corrosion coating: 0.36 g of the ZIF-8@PDA and 0.24 g of carbon black were dispersed in 25 mL of ethanol. 0.3 mL of aqueous ammonia, 0.3 mL of tetraethyl silicate, and 0.3 mL of hexadecyltrimethoxysilane were added sequentially for reaction for 4 h, and then centrifugation was performed. 50 mL of ethyl acetate and 0.5 g of thermoplastic polyurethane were added and stirred evenly to obtain a ZIF-8-based photothermal superhydrophobic anti-corrosion coating material. The coating material was sprayed onto a surface of a metal mesh and cured to obtain the ZIF-8-based photothermal superhydrophobic anti-corrosion coating.

### Comparative Example 1

Same as Example 1, except the addition of the carbon black.

### Comparative Example 2

Same as Example 1, except the addition of the hexadecyltrimethoxysilane in S2.

### Comparative Example 3

Same as Example 1, except the addition of the isopropyl phenyl diphenyl phosphate in S2.

### Comparative Example 4

Same as Example 1, except the addition of the polysilazane in S2.

### Performance Test:

### (1) Salt Spray Corrosion Test

The results of the salt spray corrosion test based on standard GB/T 10125 are shown in Table 1.

TABLE 1
Salt spray test results

| | Salt spray corrosion (day) |
|---|---|
| Example 1 | 30 |
| Example 2 | 20 |
| Example 3 | 22 |
| Example 4 | 18 |
| Comparative Example 1 | 25 |
| Comparative Example 2 | 5 |
| Comparative Example 3 | 21 |
| Comparative Example 4 | 10 |

Example 1 exhibited the best protective performance, with a salt spray resistance time of 30 days, which is prolonged by 20% compared to Comparative Example 1 (25 days) and significantly longer than those of other Comparative Examples (5-21 days). The addition of the carbon black (CB) not only filled internal pores of the coating, but also formed a three-dimensional barrier network, so that Example 1 exhibited excellent salt spray resistance.

### (2) Stability of Coating

In the present disclosure, the stability of the coatings in Examples 1-4 and Comparative Examples 1-4 was evaluated by a dual testing method of sandpaper wear and tape peeling. Sandpaper wear test: a piece of 1,000-grit sandpaper was fixed to a horizontal test bed, a coated side of a sample was faced downwards, and a 100 g weight was placed on an uncoated side of the sample. The sample performed reciprocating linear motion in a horizontal direction under traction, and each 20 cm stroke completed was counted as one wear cycle. Tape peeling test: first, 3M tape was attached flat to a surface of a coating; then, the tape and the coating were compacted along the length of the sample using a 100 g weight; and finally, the tape was completely peeled off. This process served as a tape peeling cycle. Changes in the contact angle and the rolling angle of a coating surface were recorded after the sandpaper wear and tape peeling cycles. When the contact angle was 150° or smaller or the rolling angle was 10° or smaller, the test ended. The test results are shown in Table 2.

TABLE 2
Stability of coating

| | Sandpaper | Tape |
|---|---|---|
| | wear/number | peeling/number |
| | of times | of times |
| Example 1 | 260 | 200 |
| Example 2 | 240 | 120 |
| Example 3 | 48 | 30 |
| Example 4 | 60 | 40 |
| Comparative Example 1 | 230 | 180 |
| Comparative Example 2 | 0 | 0 |
| Comparative Example 3 | 210 | 160 |
| Comparative Example 4 | 10 | 5 |

### (3) Photothermal Ice Melting Test of Coatings

Water droplets (40 microliters each) were dropped onto surfaces of an aluminum alloy, Example 1, and Comparative Example 1, respectively. The time for the water droplets to completely freeze at −15° C. in an environment without light was recorded. The test results show that in the environment without light, the freezing time of the water droplet on the surface of Example 1 was 821 s, which was 783 s longer than the freezing time of the water droplet on the surface of the aluminum alloy and 49 s longer than the freezing time of the water droplet on the surface of Comparative Example 1. After the water droplets completely froze, a xenon lamp was turned on to test the photothermal deicing ability of the coatings. The frozen water droplet did not melt on the surface of the aluminum alloy within 900 s; the frozen water droplet began to melt on the surface of Example 1 at the 16th second and completely melted at the 182nd second; and the frozen water droplet began to melt on the surface of Comparative Example 1 at the 23rd second and completely melted at the 227th second. By comparison, the coating of Example 1 has excellent anti-icing properties.

The above content is a part of the embodiments of the present disclosure and merely the best examples of the present disclosure, and does not limit the present disclosure in any form. For those skilled in the art, other modifications and improvements can be made without departing from the concept of the present disclosure, which are all within the protection scope of the present disclosure

What is claimed is:

1. A method for preparing a ZIF-8-based photothermal superhydrophobic anti-corrosion coating, comprising the following steps:
S1: preparation of ZIF-8@PDA particles: dissolving a zinc salt and dopamine hydrochloride in deionized water to form a solution A, dissolving 2-methylimidazole in deionized water to form a solution B, mixing and stirring the solution A with the solution B at room temperature to obtain a black turbid solution, and performing centrifugal washing and freeze drying to obtain the polydopamine modified ZIF-8 particles ZIF-8@PDA; and
S2: preparation of a ZIF-8-based photothermal superhydrophobic anti-corrosion coating: dispersing the ZIF-8@PDA and a carbon material in a certain ratio in ethanol by stirring, allowing the mixture to react with modifiers in an alkaline environment, performing centrifugation, adding an organic solvent and an adhesive, performing stirring evenly to obtain a ZIF-8-based photothermal superhydrophobic anti-corrosion coating material, spraying the coating material onto a surface of a substrate, and curing the coating material to obtain the ZIF-8-based photothermal superhydrophobic anti-corrosion coating;
the modifiers being tetraethyl silicate and hexadecyltrimethoxysilane in S2.

2. The method for preparing a ZIF-8-based photothermal superhydrophobic anti-corrosion coating according to claim 1, wherein in S1, the zinc salt is one of zinc nitrate, zinc acetate, and zinc gluconate; the mass concentration of the dopamine hydrochloride in the solution A is 0.1 g/mL, the mass concentration of the zinc salt in the solution A is 0.02 g/mL, and the mass ratio of the zinc salt to the 2-methylimidazole is 1:(5-10); and the stirring time at room temperature is 12-48 h.

3. The method for preparing a ZIF-8-based photothermal superhydrophobic anti-corrosion coating according to claim 2, wherein the stirring time at room temperature is 24 h in S1.

4. The method for preparing a ZIF-8-based photothermal superhydrophobic anti-corrosion coating according to claim 1, wherein in S2, the mass ratio of the ZIF-8@PDA to the carbon material is 1:(0.25-1); and the carbon material is one or more of carbon black, carbon nanotubes, and graphene.

5. The method for preparing a ZIF-8-based photothermal superhydrophobic anti-corrosion coating according to claim 1, wherein 6 g of a mixture of the ZIF-8@PDA with the carbon material is dispersed per 250 mL of ethanol in S2.

6. The method for preparing a ZIF-8-based photothermal superhydrophobic anti-corrosion coating according to claim 1, wherein the alkaline environment is formed by adding an ammonia solution to ethanol in S2.

7. The method for preparing a ZIF-8-based photothermal superhydrophobic anti-corrosion coating according to claim 5, wherein in S2, the modifiers are tetraethyl silicate and hexadecyltrimethoxysilane, and the volume ratio of the ethanol to the ammonia solution to the tetraethyl silicate to the hexadecyltrimethoxysilane is 50:0.6:0.6:0.6.

8. The method for preparing a ZIF-8-based photothermal superhydrophobic anti-corrosion coating according to claim 1, wherein the adhesive is one of polysilazane, isopropyl phenyl diphenyl phosphate, epoxy resin, polydimethylsiloxane, and thermoplastic polyurethane in S2.

9. The method for preparing a ZIF-8-based photothermal superhydrophobic anti-corrosion coating according to claim 1, wherein in S1, the carbon material is carbon black; and in S2, the organic solvent is butyl acetate, and the adhesive is polysilazane and isopropyl phenyl diphenyl phosphate.
